(19) United States
(12) Patent Application Publication
(10) Pub. No.: US 2021/0172563 A1
(43) Pub. Date: Jun. 10, 2021

(54) HOLLOW BALL MOUNT SYSTEM AND METHOD

(71) Applicant: David Graham Clark, Clark, CO (US)

(72) Inventor: David Graham Clark, Clark, CO (US)

(73) Assignee: New Ideas Manufacturing, LLC, Englewood, CO (US)

(21) Appl. No.: 16/705,579

(22) Filed: Dec. 6, 2019

(51) Int. Cl. F16M 11/14; F16C 11/06; G03B 17/56

(52) U.S. Cl. CPC F16M 11/14; G03B 17/561; F16C 11/0604; F16C 11/0685

(57) ABSTRACT

The present invention relates to a hollow ball mount system having a hollow spherical structure. The hollow spherical structure includes an internal volume, an external surface, and an outer wall. A stem is adjoined to the hollow spherical structure, the stem having a proximal end and a distal end, wherein the stem extends outward and substantially normal to the external surface. An interfacing surface is positioned upon the distal end of the stem. The flat interfacing surface is configured for mounting and securing articles, such as camera equipment, sporting equipment, and lighting. In further embodiments, the flat interfacing surface includes an attachment member and/or an adapter to substantially match the size and shape of the articles to be adjoined to the hollow ball mount.

### BACKGROUND OF THE INVENTION

### 1. Field of the Invention

The present invention relates to a hollow ball mount for articulating an article about a centroid.

### 2. Description of Related Art

Two of the most important characteristics of tripod equipment are weight and stiffness. Photographers often travel or hike and low-weight gear is essential for remaining agile, reducing fatigue, and preventing injuries. However, the end goal is to create clear, sharp images and weight savings cannot compromise the rigidity of the tripod system. The gear must stay strong and dampen vibration to retain the clarity of photos especially in adverse condition with long exposures.

Consequently, there is a need for a lightweight ball mounting system without compromising rigidity or stabilization of the camera article.

### BRIEF SUMMARY OF INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a particular object of the present invention to provide a hollow ball mount system and method for reducing weight while not compromising structural integrity. Secondly, the hollow ball mount system allows for cost saving at the time of manufacturing with reductions in material costs.

Another object of the present invention is to allow the user the ability to carry multiple hollow ball mounts configured to interface with different articles for mounting, while not incurring large amounts of extra weight.

In order to do so, a hollow ball mount system is provided having a hollow spherical structure. The hollow spherical structure further having an internal volume, an external surface, and an outer wall. A stem is adjoined to the hollow spherical structure, the stem having a proximal end and a distal end, wherein the stem extends outward and substantially normal to the external surface. An interfacing surface is positioned upon the distal end of the stem. The interfacing surface is configured for mounting and securing articles, such as camera equipment, sporting equipment, and lighting. In further embodiments, the interfacing surface includes an attachment member and/or an adapter to substantially match the size and shape of the articles to be adjoined to the hollow ball mount.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE FIGURES

The detailed description of some embodiments of the invention is made below with reference to the accompanying figures, wherein like numerals represent corresponding parts of the figures.

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an exemplary front view of one embodiment of the hollow ball mount system joined to an exemplary tripod and an exemplary camera article.

FIG. 2 shows an exemplary perspective view of one embodiment of the hollow ball mount system.

FIG. 3 shows an exemplary front view of one embodiment of the hollow ball mount system.

FIG. 4 shows an exemplary front view of one embodiment of the hollow ball mount system.

FIG. 5 shows an exemplary side view of one embodiment of the hollow ball mount system and parting line 6-6.

FIG. 6 shows an exemplary cross-sectional view of one embodiment of the hollow ball mount system, taken along parting line 6-6 of FIG. 5.

FIG. 7 shows an exemplary cross-sectional view of one embodiment of the hollow ball mount system, taken along parting line 6-6 of FIG. 5.

FIG. 8 shows an exemplary exploded perspective view of one embodiment of the hollow ball mount system joined to an exemplary camera article.

### DETAILED DESCRIPTION OF INVENTION

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

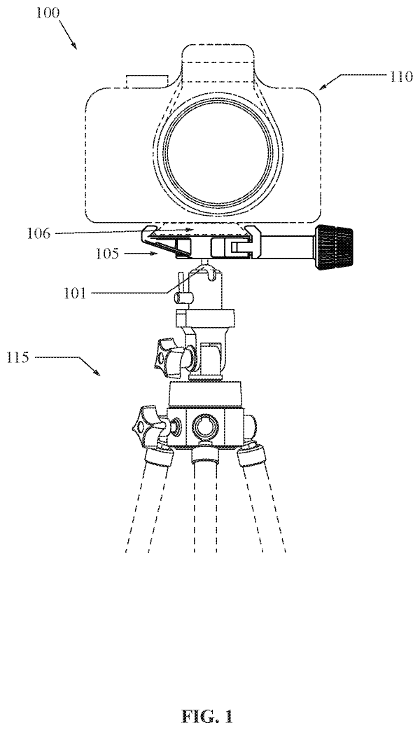

Referring now to FIG. 1, a hollow ball mount system 100 is shown. The hollow ball mount system 100 enabling a user to save weight while not compromising structural integrity of the hollow ball mount system 100. Advantageously, the hollow ball mount system 100 enabling a user custom configuration to match articles of different sizes and manufacturers by interchanging different embodiments of the hollow ball mount system 100. For example, a user may carry two embodiments of the hollow ball mount system 100, one configured for use with binoculars and one configured for use with the camera article 110, all while retaining and carrying the same or less weight as one traditional camera ball mount made of a solid material. The hollow ball mount system 100 comprises a hollow spherical structure 101 enabling a user to articulate a mount 105 and/or a camera article 110 about a tripod member 115. It should be appreciated by those skilled in the art, that the conception as well as the disclosed methods and structures herein may be readily utilized as a basis for modifying, securing, or designing other structures outside of the camera industry articles shown in FIG. 1 for carrying out the same purposes of the present disclosure. Further, it should be realized by those skilled in the art that such equivalent structures outside the camera industry do not depart from the spirit and scope of the invention as set forth in the appended claims. For example, the present invention may be used with different sporting equipment, without limitation, such as optics, firearms, or lighting systems.

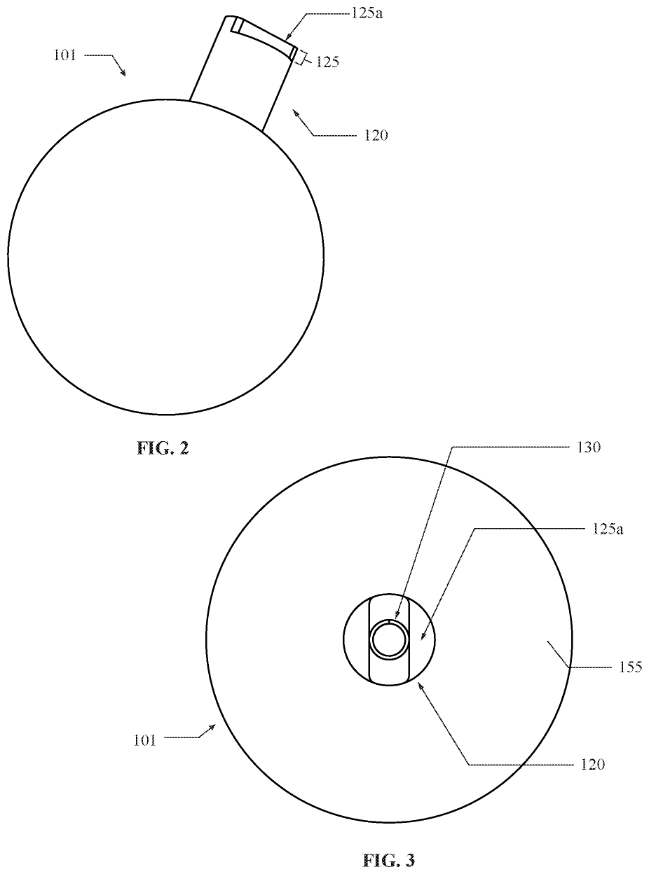

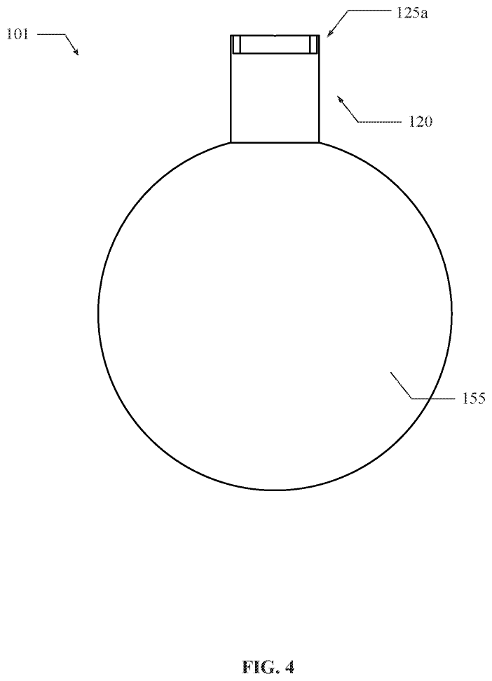

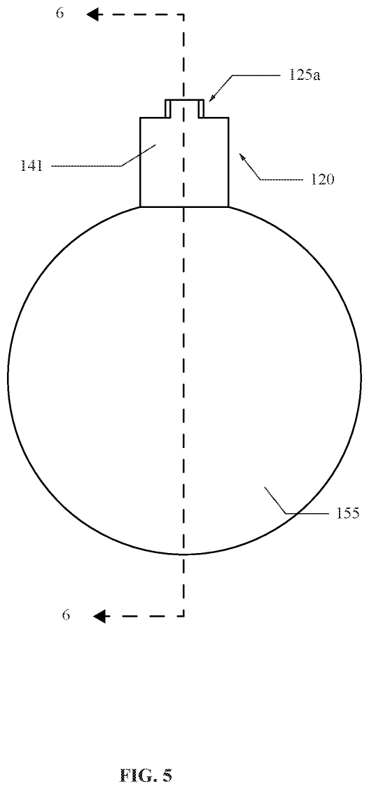

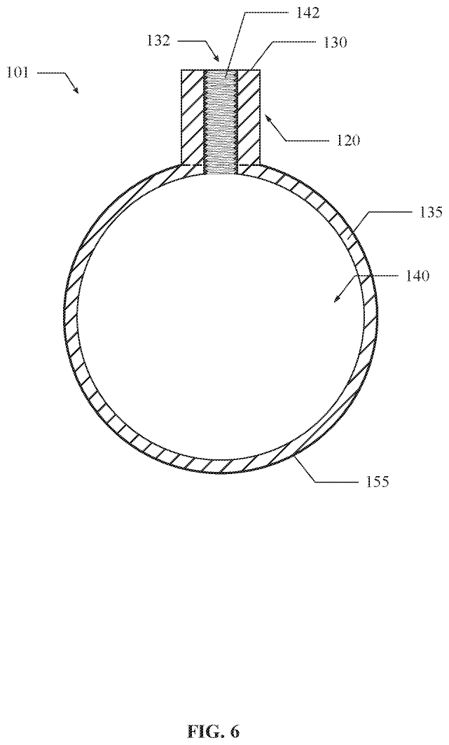

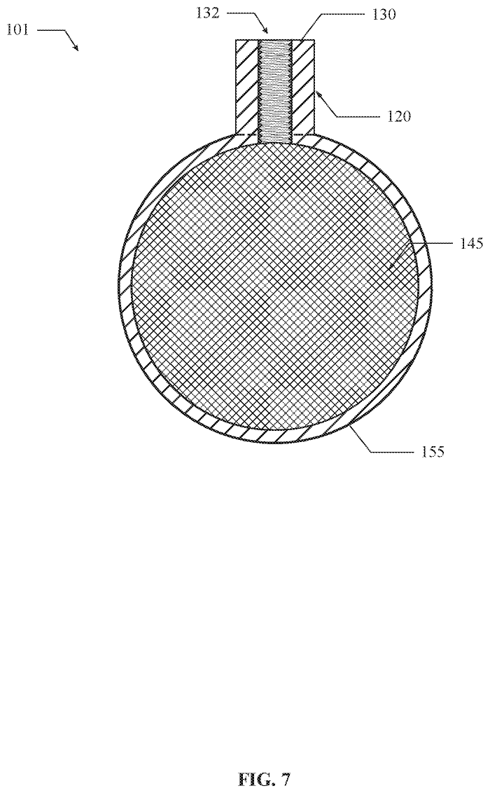

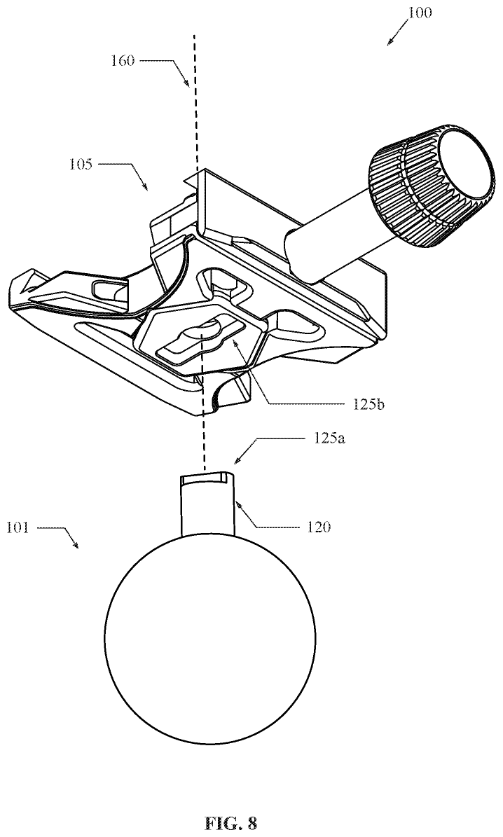

Referring now to FIGS. 2-8, the hollow spherical structure 101 is shown. In one embodiment, the hollow spherical structure 101 includes a first external surface 155. The hollow spherical structure 101 further comprising an outer wall 135 and an internal volume 140. The outer wall 135 may be manufactured at a varying thickness or a constant thickness of any dimension. Next, a stem 120 is adjoined to the hollow spherical structure 101. The joining of the hollow spherical structure 101 and the stem 120 can be carried out by any process of a production set. For example, at least one process of the production set, without limitation, may consist of CNC machining, casting, additive manufacturing, molding, forging, forming, bending, shearing, and pressing. The stem 120 includes a proximal end and a distal end. The distal end of the stem 120 is configured to distance the mount 105 from the hollow spherical structure 101 for free rotation during movement of the camera article 110 during operation. In some embodiments, the stem 120 further comprises a top interfacing surface 130 aligned about a plane substantially perpendicular to the first direction 160, as shown in FIG. 8. In other embodiments, the top interfacing surface 130 may be flat, curved, concave, or convex to match the size and shape of various articles being adjoin thereto.

In some embodiments, the top interfacing surface 130 of the hollow ball mount system 100 further comprises an attachment member 132 and/or an adapter 125. The attachment member 132 aiding in adjoining the hollow ball mount system 100 to the mount 105 and/or the camera article 110. In embodiments having one or more adapters 125 positioned upon the top interfacing surface 130, the one or more adapters 125 aid in the correct orientation during assembly. In embodiments of the hollow ball mount system 100 having the attachment member 132, the attachment member 132 may be chosen from at least one member of an attachment set consisting of: a magnet, a clip, a heat-shrink material flange, a press-fit, a chemical weld, a slide-fit, a clamp, a spring, a fastener, an elastic member, a threaded opening, and an adhesive.

As shown in FIG. 8, the adapter 125 is configured to substantially match and conform to a portion of a commercially available camera article 110. In some embodiments, The adapter 125 comprises a male adapter portion 125a and a female adapter portion 125b configured to substantially align and match during assembly. In other embodiments, the adapter 125 is configured to receive a camera article 110 of a number of different manufacturers, such that the hollow ball mount system 100 may be used with the number of different manufacturers.

As further illustrated in FIG. 8, the mount 105 and/or the adapter 125 include a connection pattern configured to match commercially available camera mounts. By way of non-limiting example, the commercially available mounts 105 and/or camera articles 110 may be articles made by LVG®, Really Right Stuff®, Benro®, Manfrotto®, and the like. The various embodiments of hollow ball mount system 100 are configured to be easily swapped out entirely when needed for use with the different brands. It should be understood that other adapters 125 having additional connection patterns configured to match with connection patterns of additional brands may be provided without departing from the scope and spirit of the invention.

Advantageously, the arrangement and construction of materials described above allow for weight reduction in the hollow ball mount system 100 without compromising the rigidity of the tripod member 115. During use, in the art of photography, the system must stay rigid and dampen vibration to retain clarity during photography shoots, especially in adverse environmental conditions when long exposures are required. Also, as traveling and carrying equipment is necessary, light weight components are ideal.

Common mounting plates typically comprise a square or rectangular member with biasing member adjoined to the perimeter edge of the mounting plate 106, such as an angled edge or dovetail mount. Exemplary mounting plates may further comprise quick-releases, fasteners, threaded ports, slots, linear guide systems, textured surfaced, clamps, and other assessor members. In some embodiments, the top interfacing surface 130 may further comprise the attachment member 132 embodied as a threaded aperture designed to receive a fastener that is first passed through the mount 105 and/or the mounting plate 106. Next the fastener is tightened to temporarily secure the mount 105 and/or the mounting plate 106 to the stem 120 of the hollow ball mount system 100.

In some embodiments, the top interfacing surface 130 may further comprise biasing members being at least one a member of a connection set consisting of: a slot, a rail, a joint, a magnet, an elastic member, a snap-fit, a clamp, a clip, and a fastener. In other embodiments, the rail and the joint of the connection set are chosen from, by way of non-limiting example, a rail set consisting of: a dovetail rail, a tongue and groove joint, a linear guide rail, a dado joint, and a dovetail joint.

In some embodiments, it may be desirable that the hollow ball mount system 100 includes at least one member of an identification set consisting of: an alphanumeric identification, the user's name, a symbolic shape, a company brand, a numeric identification number, a QR code, a barcode, an RFID tag, or any combination thereof. For example, the first external surface 155 may include a numeric identification number that conveys the diameter of the hollow spherical structure 101. In some embodiments, the first external surface 155 of the hollow spherical structure 101, the internal surface 142 of the first protrusion, and/or the second external surface 141 of the stem 120 further comprises an external texture. The external texture further includes at least one member of a texture set consisting of: indentations, extrusions, knurling, a rough surface, and bumps.

A method for the production of the hollow ball mount system 100 is also described herein. In one embodiment, a method of manufacturing a hollow ball mount system 100 comprises steps as follows. First, creating a first half spherical structure and creating a second half spherical structure by at least one process of the production set. Next, adjoining the first half spherical structure to the second half spherical structure to create a hollow spherical structure 101 by at least one joining process of a joining set, without limitation, consisting of: welding, brazing, soldering, sintering, adhesive bonding, fastening, and press fitting. Next, during manufacturing, adjoining of the stem 120 to the hollow spherical structure 101 at an angle substantially normal to the hollow spherical structure 101. This is carried out through at least one process of the joining set to form the hollow ball mount system 100. In some embodiments, the method may also include the step of configuring a shape of the stem 120 to interface with a predetermined shape of a commercially available adapter, article, or camera article 110.

Smooth and consistent movement of a camera article adjoined to the tripod member 115 is critical in capturing the desired image or carrying out a desired function of an article upon the tripod member 115. In this case, the method may further comprise a step of finishing an external surface of the hollow ball mount system 100 to a desired state by at least one process of a finishing set. The finishing set, without limitation, consisting of electroplating, anodizing, buffing, powder coating, painting, immersion plating, cladding, hardening, electropolishing, electroless plating galvanizing, vapor deposition, blasting, sanding, tumbling, peening, knurling, grinding, glazing, blanching, or any combination thereof.

In other embodiments, the hollow ball mount system 100 may further comprise a structural member 145 within the internal volume 140. The structural member being at least one member of a structure set, without limitation, consisting of: a lattice structure, a first material, a patterned structure, a liquid or any combination thereof. For example, the structural member may be a solid rubber core within the hollow spherical structure 101. In other embodiments, during manufacturing, the internal volume 140 may be interconnected by a lattice structure to provide further rigidity. No limitation is placed on the patterned structure or the lattice structure that may be constructed within the internal volume 140.

In reference to FIGS. 1-8, the present invention may include the following elements:
a hollow ball mount system 100
a hollow spherical structure 101
a mount 105
a mounting plate 106
a camera article 110
a tripod member 115
a stem 120
an adapter 125
a male adapter portion 125a
a female adapter portion 125b
a top interfacing surface 130
an attachment member 132
an outer wall 135
an internal volume 140
a second external surface 141
an internal surface 142
a structural member 145
a first external surface 155
a first direction 160

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” refers to an amount that is near the stated amount by about 0%, 5%, or 10%, including increments therein.

Unless otherwise defined, all technical terms used herein have the same meaning as commonly understood by one of ordinary skill in the art to which this disclosure belongs.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, ¶6. In particular, any use of “step of” in the claims is not intended to invoke the provision of 35 U.S.C. § 112, ¶6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A hollow ball mount system comprising:
a hollow spherical structure having an internal volume, an external surface, and an outer wall;
a stem having a proximal end and a distal end, wherein the stem extends outward and substantially normal to the external surface of the hollow spherical structure;
an interfacing surface positioned upon the distal end of the stem; and,
a first mode of operation wherein the flat interfacing surface engages with a camera article.

2. The system of claim 1, wherein the interfacing surface includes an attachment member.

3. The system of claim 1, wherein the interfacing surface includes an adapter.

4. The system of claim 2, wherein the attachment member is at least one member of an attachment set consisting of: a magnet, a clip, a heat-shrink material flange, a slide-fit, a clamp, a spring, a fastener, an elastic member, a threaded opening, and an adhesive.

5. The system of claim 3, wherein the adapter is configured to substantially match and conform to a portion of a commercially available camera article.

6. The system of claim 3, wherein the adapter is interchangeable with additional adapters, wherein each adapter is configured to receive a camera article of a number of different manufacturers, such that the hollow ball mount system may be used with the number of different manufacturers.

7. The system of claim 1, wherein the external surface of the hollow spherical structure includes an external texture.

8. The system of claim 7, wherein the external texture comprises at least one member of a texture set consisting of: indentations, extrusions, knurling, a rough surface, and bumps.

9. The system of claim 1, wherein the internal volume of the hollow spherical structure comprises an internal lattice structure.

10. A method of manufacturing a hollow ball mount comprising:
creating a first half spherical structure;
creating a second half spherical structure;
adjoining the first half spherical structure to the second half spherical structure to create a hollow spherical structure; and,
adjoining a stem to the hollow spherical structure at an angle substantially normal to the hollow spherical structure to form the hollow ball mount.

11. The method of claim 10, further comprising:
configuring a shape of the stem to interface with a predetermined shape of a commercially available article.

12. The method of claim 10, wherein creating the first half spherical structure and/or creating the second half spherical structure is carried out by at least one process of a production set consisting of CNC machining, casting, additive manufacturing, molding, forging, forming, bending, shearing, and pressing.

13. The method of claim 10, wherein adjoining the first half spherical structure to the second half spherical structure is carried out at least one joining process of a joining set consisting of: welding, brazing, soldering, sintering, adhesive bonding, fastening, and press fitting.

14. The method of claim 10, wherein adjoining the stem to the hollow spherical structure is carried out at least one joining process of a joining set consisting of: welding, brazing, soldering, sintering, adhesive bonding, fastening, and press fitting.

15. The method of claim 10, further comprising: finishing an external surface of the hollow ball mount to a desired state.
